(19) United States
(12) Patent Application Publication
(10) Pub. No.: US 2018/0357482 A1
(43) Pub. Date: Dec. 13, 2018

(54) SYSTEMS AND METHODS FOR REAL TIME PROCESSING OF EVENT IMAGES

(71) Applicant: Running Away Enterprises LLC, Buffalo Grove, IL (US)

(72) Inventors: Steve Ginsburg, Highland Park, IL (US); Brian Kieffer, Buffalo Grove, IL (US)

(21) Appl. No.: 16/003,812

(22) Filed: Jun. 8, 2018

Related U.S. Application Data
(60) Provisional application No. 62/516,998, filed on Jun. 8, 2017.

(51) Int. Cl. G06K 9/00; H04N 5/232

(52) U.S. Cl. CPC G06K 9/00677; H04N 5/23229; H04L 67/42; G06K 9/00684; G06K 9/00718

(57) ABSTRACT

Systems and methods for processing an image of an event captured by an image capture device is provided. The image is received at an image processor device positioned at the event. The image processor device is used to create metadata relating to the image, format the image for subject identification processing, insert the metadata into the image, and transmit the image, if one or more conditions exist at a site of the event, over a network to one or more servers operable to perform subject identification processing.

### CROSS REFERENCE TO RELATED APPLICATIONS

This application claims priority to U.S. Provisional Application No. 62/516,998, which is hereby incorporated by reference in its entirety.

### BACKGROUND OF THE INVENTION

It is common in events and gatherings to have one or more photographic devices present in order to capture moments as they take place. Sometimes the photographic devices are operated by photographers and other times they are attached to stands and operated at certain intervals or through remote control. Regardless of the manner in which the photos are taken, the eventual output is a number of photos that may have meaning to one or more of the participants or subjects present at the event or gathering. It is often desirable to the participants or the organizers of events to distribute these photos to the participants.

A problem exists, however, in that it is difficult to distribute the photos to the participants in a timely manner. Generally, when the event is over, the photos are collected in a central location, sorted, and indexed. The participants are then notified that there are photos in which they may be interested. These steps take time and often result in the participants not being notified for hours or even days after which the event has concluded. Accordingly, what is needed are methods and systems for real time processing of event images.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

In one embodiment, a method for processing an image of an event captured by an image capture device is provided. The image is received at an image processor device positioned at the event. The image processor device is used to create metadata relating to the image, format the image for subject identification processing, insert the metadata into the image, and transmit the image, if one or more conditions exist at a site of the event, over a network to one or more servers operable to perform subject identification processing.

In one embodiment, an image processing device is provided. The image processing devices includes a processor and a memory coupled with the processor, the memory comprising executable instructions that when executed by the processor cause the processor to effectuate operations. The operations include: receiving the image at the image processing device only when the image processing device is positioned at an event site; creating metadata relating to the image; formatting the image for subject identification processing; inserting the metadata into the image; and transmitting the image, if one or more conditions exist at the event site, over a network to one or more servers operable to perform subject identification processing.

In one embodiment a method is provided. At least on image capture device and at least one image processing device are positioned at an event. The image capture device is utilized to capture one or more images of the event, wherein the image includes at least one subject. The image processing device is caused to pull the one or more images from the image capture device upon the image capture device capturing the one or more images. The image processing device is utilized create metadata relating to the image; format the image for subject identification processing; insert the metadata into the image; and transmit the image, if one or more conditions exist at a site of the event, over a network to one or more servers operable to perform subject identification processing.

### BRIEF DESCRIPTION OF THE DRAWINGS

A more detailed understanding may be had from the following description, given by way of example in conjunction with the accompanying drawings wherein:

FIG. 1 illustrates an exemplary environment for performing real time processing of event images;

FIG. 2 illustrates an exemplary system for performing real time processing of event images in the environment of FIG. 1;

FIG. 3 depicts an exemplary method of performing real time processing of event images;

FIG. 4 is an exemplary block diagram representing a computer system in which aspects of the systems and methods disclosed herein or portions thereof may be incorporated.

### DETAILED DESCRIPTION

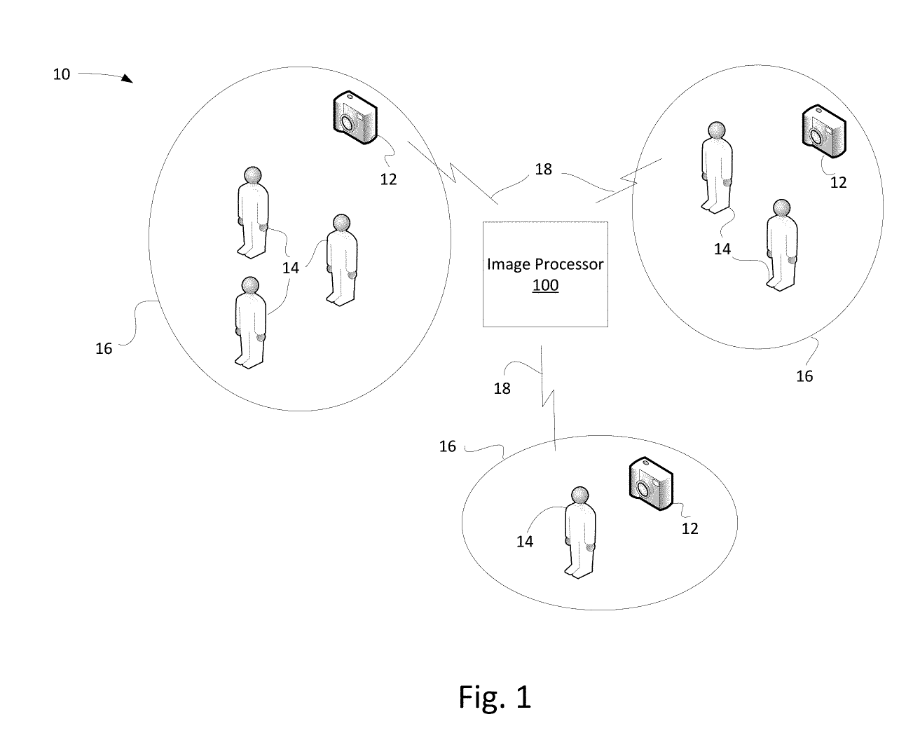

FIG. 1 depicts an exemplary environment 10 in which real time processing of event images may occur. Environment 10 includes one or more instance of an image capture device 12, one or more participants 14, one or more zones 16, and an image processor 100, which is in communication with image capture device(s) 12 through one or more communication links 18.

Image capture device 12 in one example is a digital camera. In another example, image capture device 12 may be a hardware device in which a camera is component or subcomponent. For instance, image capture device 12 may be a smartphone or a tablet. Image capture device 12 in one example may be connected to or part of a vehicle, such as a UAV or robotic vehicle. Image capture device 12 in one example may be stationary, such as a red light camera or surveillance camera. Image capture device 12 may be operated by a photographer or operated automatically or remotely. The preceding examples are provided for illustrative purposes only and this disclosure should not be limited to a particular image capture device 12.

Participants 14 in one example are participants in an event or gathering. For example, participants 14 may be participants in a sporting event, such as a running, walking or cycling race. In another example, participants 14 may be attendees of a concert or other performance gathering. In another example, participants 14 may be students of a school or a summer camp. In another example, participants 14 may be members of the public gathering or walking on a sidewalk or other public space. Image capture devices 12 capture images that may include one or more participants 14 who are subjects of the images. Real time processing in the embodiments disclosed herein are directed at providing participants 14 with copies of images, within which they are depicted, in minutes or even moments after which they are captured in the images.

Zones 16 in one example are locations or areas in which one or more image capture device 12 operates. Zones 16 may include one or more image capture devices 12 and one or more participants 14. Zones 16 provide a way to index the source of an image (e.g. a particular image capture device 12) to a physical location. This may be helpful in identifying a participant 14 from an image.

Image processor 100 is positioned at the location of an event or gathering and performs processing on images captured from image capture devices 12 while an event or gathering is taking place. Image processor 100 receives images from image capture devices 12, as the images are captured, over communication links 18. Communication links 18 in one example are wireless communication links, such as Bluetooth or WI-Fi. In another example, communication links 18 may be wired communication links, such as USB or Ethernet communication links. It should be noted that image processor 100 is shown as a singular device for illustrative purposes only. It should be understood that additional image processors 100 may be included to cover an event. In addition, image processor 100 may be mobile or stationary. For instance, an operator could move image processor 100 around an event. In another instance, image processor may be connected to a vehicle, such as a UAV or a robotic vehicle moving around an event.

Upon receipt of images, image processor 100 performs processing steps on the images to prepare the images for optimal identification of participants or subjects within the images. In one example, processing includes generating metadata for images and inserting the metadata within the image file. Such metadata includes but is not limited to one or more of the date, time, event ID, geographic location, photographer ID, image capture device ID, zone number, and the like.

In another example, processing includes scaling the image such that the image is optimally sized for data transmission and additional data processing. For example, images may be utilized as inputs to a facial recognition system to identify participants in an image. Scaling the image to an optimal size makes running a facial recognition system more efficient. In another example, an event may be a sporting event, such as a race. Participants in such races often wear bibs or tags to identify them. A bib or tab recognition program can be used to identify a participant by extracting a bib or tag marker (e.g. a number) and cross referencing the bib or tag to a list of participants. Bib and tag recognition programs run more efficiently if the photo data input into the program is of an optimal size.

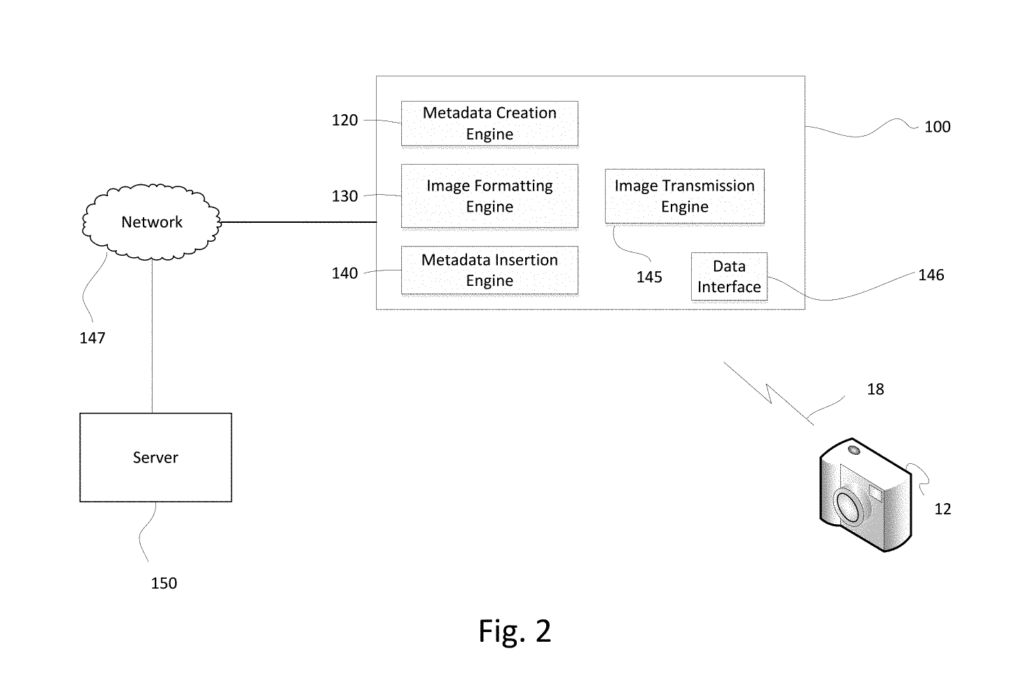

Referring to FIG. 2, image processor 100 in one example includes, metadata creation engine 120, image formatting engine 130, metadata insertion engine 140, image transmission engine 145, and data interface 146. Image processor 100 may be communicatively connected with network 147 and one or more servers 150. An entity, such as an individual or a business may own or have control of image processor 100, network 147, and/or server 150. In another embodiment, network 147 and/or server(s) 150 may be provided by a network service provider, including a cloud service provider. In one embodiment, server(s) 150 may be provided by a service provider that stores and processes images. For instance, server(s) may be part of a cloud service that performs services to identify participants 114 in images, including facial recognition and/or bib or tag recognition. Server(s) 150 in one example may comprise functionality that communicates with participants 114 to notify them of the availability of images in which they are present. Server(s) 150 may provide the participants with the opportunity to download or purchase such images.

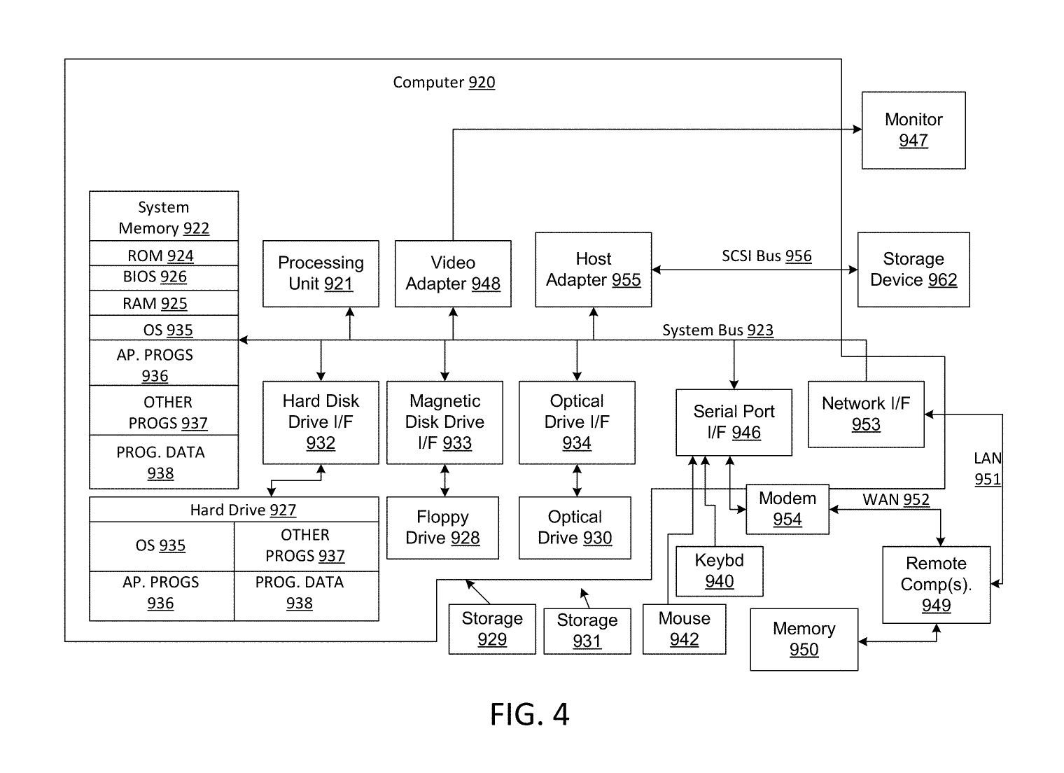

With continued reference to FIG. 1, metadata creation engine 120, image formatting engine 130, metadata insertion engine 140 and image transmission engine 145 are logical elements that may be implemented in the form of software (e.g., computer-executable instructions) stored in a memory of, and executing on a processor of a computing device, such as a smartphone, tablet, or a computer system. An exemplary computing device is provided in FIG. 4.

Metadata creation engine 120 in one example creates the metadata for each image that image processor 100 receives. Such metadata includes, but is not limited to the time, date, event ID, zone ID, photographer ID, image capture device ID relating to the image.

Image formatting engine 130 in one example processes each image to insure that it is at an optimal size and scale for transmission over network 147 and for use in backend processing, such as facial recognition and bib or tag recognition. Image formatting engine 130 in one example makes a copy of each image it receives such that there is a master image and a copy. Image formatting engine 130 processes the copy of the image and retains the master image.

Metadata insertion engine 140 inserts metadata into the copy of the image file.

Image transmission engine 145 in one example makes a determination as to whether or not to send images over network 147 to server(s) 150. In one embodiment, such a determination is made by assessing the signal strength that image processor 100 has with respect to network 147. For instance, if the signal strength is low, then image transmission engine 145 may elect to hold images in a queue until sufficient signal strength is achieved to send the images in an optimal manner. Upon achieving sufficient signal strength, image transmission engine 145 will transmit images over data interface 146.

Data interface 146 in one example provides the functionality to transmit and receive image data to/from network 147 and image capture device 12. Data interface 146 may include wireless (e.g. Bluetooth, cellular, Wi-Fi) and wired (e.g. Ethernet and USB) interfaces.

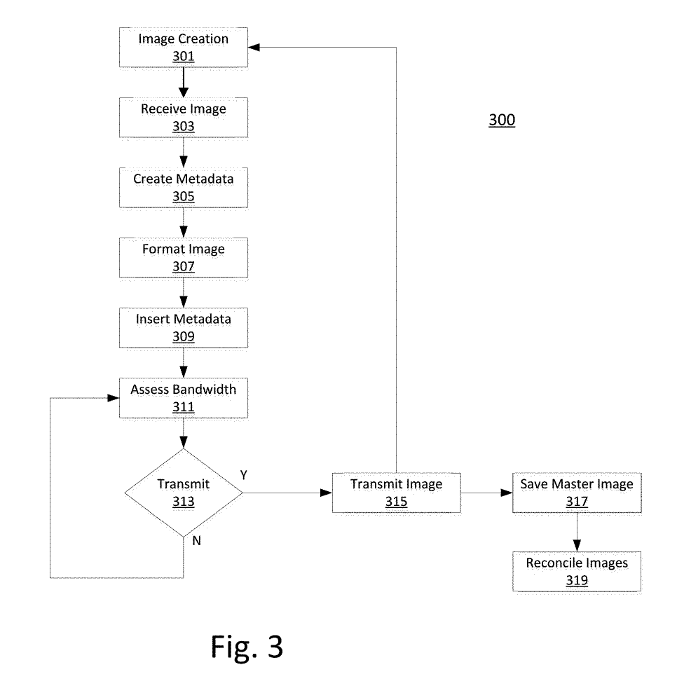

Referring to FIG. 3, an exemplary process 300 of image processing will now be provided for illustrative purposes.

In step 301, the process 300 begins with image creation. It should be noted that image creation may include a single image capture device 12 creating images or multiple image capture devices 12 creating images in parallel. In addition, more than one image processor 100 may be operating in parallel with one or more image capture devices 12

In step 303, one or more images is received by image processing device 100. In one embodiment, images may be pushed from image capture devices 12 to image processor 100. In another example, images may be pulled from image capture devices 12 by image processor 100. In one example, images may be sent in batches to image processor 100. In another example, image processor 100 may receive images as they are created.

In step 305, metadata creation engine 120 creates metadata of the images. In step 307, image formatting engine 130 creates copies of the images and formats the images by scaling the images to an appropriate size. In step 309, metadata insertion engine 140 inserts the metadata into the copies of the images. It should be noted that the steps of process 300 are shown in a particular order, but this disclosure should not be so limited. It should be understood that steps of process 300 could be rearranged or omitted. In addition, other steps could be added to process 300.

In step 311, image transmission engine 145 assesses the bandwidth available for image processor 100 to transmit images over network 147. If sufficient bandwidth exists, then in step 313, image transmission engine 145 determines to transmit the images over network to server(s) 150. If sufficient bandwidth does not exist, then image transmission engine will continue to assess bandwidth in step 311. If sufficient bandwidth does exist, then in step 315 the images are transmitted to server(s) 150 where the images will undergo further processing as was described above.

In step 317, the master image is saved. In one example, the master image may be saved on image processor. In another example, the master image may be saved on the memory of image capture devices 12. Later, the master images will be provided to server(s) 150. The images may be provided in a number of ways. For example, the master images may be saved to memory devices and manually uploaded to server(s) or transferred through a high speed data upload service. In step 319, the master images will be reconciled to the processed images transmitted in step 315. Accordingly, each processed image will have a corresponding master image.

Upon receipt of the processed images, server(s) 150 may identify one or more participants 14 in the images through the use of techniques, such as facial recognition, bib or tag recognition, and/or the use of the metadata inserted in the images. The server(s) 150 may be used to notify the participants 14 that there are images available in which they are present. In another example, the server(s) 150 may notify third parties (family, friends, etc.) of the presence of a participant 14 in an image. The recipients of the notification may then have the option of downloading or purchasing the images. Due to the processing that takes place in while the event is occurring, the participants 14 receive notifications and may obtain copies of images contemporaneously with the occurrence of the event. Accordingly, there is no time lag between image capture and making images available to participants 14 as with conventional systems.

FIG. 4 and the following discussion are intended to provide a brief general description of a suitable computing environment in which the methods and systems disclosed herein or portions thereof may be implemented. Although not required, the methods and systems disclosed herein is described in the general context of computer-executable instructions, such as program modules, being executed by a computer, such as a client workstation, server, personal computer, or mobile computing device such as a smartphone. Generally, program modules include routines, programs, objects, components, data structures and the like that perform particular tasks or implement particular abstract data types. Moreover, it should be appreciated the methods and systems disclosed herein and/or portions thereof may be practiced with other computer system configurations, including hand-held devices, multi-processor systems, microprocessor-based or programmable consumer electronics, network PCs, minicomputers, mainframe computers and the like. A processor may be implemented on a single-chip, multiple chips or multiple electrical components with different architectures. The methods and systems disclosed herein may also be practiced in distributed computing environments where tasks are performed by remote processing devices that are linked through a communications network. In a distributed computing environment, program modules may be located in both local and remote memory storage devices.

FIG. 4 is a block diagram representing a general purpose computer system in which aspects of the methods and systems disclosed herein and/or portions thereof may be incorporated. As shown, the exemplary general purpose computing system includes a computer 920 or the like, including a processing unit 921, a system memory 922, and a system bus 923 that couples various system components including the system memory to the processing unit 921. The system bus 923 may be any of several types of bus structures including a memory bus or memory controller, a peripheral bus, and a local bus using any of a variety of bus architectures. The system memory includes read-only memory (ROM) 924 and random access memory (RAM) 925. A basic input/output system 926 (BIOS), containing the basic routines that help to transfer information between elements within the computer 920, such as during start-up, is stored in ROM 924.

The computer 920 may further include a hard disk drive 927 for reading from and writing to a hard disk (not shown), a magnetic disk drive 928 for reading from or writing to a removable magnetic disk 929, and an optical disk drive 930 for reading from or writing to a removable optical disk 931 such as a CD-ROM or other optical media. The hard disk drive 927, magnetic disk drive 928, and optical disk drive 930 are connected to the system bus 923 by a hard disk drive interface 932, a magnetic disk drive interface 933, and an optical drive interface 934, respectively. The drives and their associated computer-readable media provide non-volatile storage of computer readable instructions, data structures, program modules and other data for the computer 920. As described herein, computer-readable media is a tangible, physical, and concrete article of manufacture and thus not a signal per se.

Although the exemplary environment described herein employs a hard disk, a removable magnetic disk 929, and a removable optical disk 931, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, magnetic disk 929, optical disk 931, ROM 924 or RAM 925, including an operating system 935, one or more application programs 936, other program modules 937 and program data 938. A user may enter commands and information into the computer 920 through input devices such as a keyboard 940 and pointing device 942. Other input devices (not shown) may include a microphone, joystick, game pad, satellite disk, scanner, or the like. These and other input devices are often connected to the processing unit 921 through a serial port interface 946 that is coupled to the system bus, but may be connected by other interfaces, such as a parallel port, game port, or universal serial bus (USB). A monitor 947 or other type of display device is also connected to the system bus 923 via an interface, such as a video adapter 948. In addition to the monitor 947, a computer may include other peripheral output devices (not shown), such as speakers and printers. The exemplary system of FIG. 4 also includes a host adapter 955, a Small Computer System Interface (SCSI) bus 956, and an external storage device 962 connected to the SCSI bus 956.

The computer 920 may operate in a networked environment using logical connections to one or more remote computers, such as a remote computer 949. The remote computer 949 may be a personal computer, a server, a router, a network PC, a peer device or other common network node, and may include many or all of the elements described above relative to the computer 920, although only a memory storage device 950 has been illustrated in FIG. 4. The logical connections depicted in FIG. 4 include a local area network (LAN) 951 and a wide area network (WAN) 952. Such networking environments are commonplace in offices, enterprise-wide computer networks, intranets, and the Internet.

When used in a LAN networking environment, the computer 920 is connected to the LAN 951 through a network interface or adapter 953. When used in a WAN networking environment, the computer 920 may include a modem 954 or other means for establishing communications over the wide area network 952, such as the Internet. The modem 954, which may be internal or external, is connected to the system bus 923 via the serial port interface 946. In a networked environment, program modules depicted relative to the computer 920, or portions thereof, may be stored in the remote memory storage device. It will be appreciated that the network connections shown are exemplary and other means of establishing a communications link between the computers may be used.

Computer 920 may include a variety of computer readable storage media. Computer readable storage media can be any available media that can be accessed by computer 920 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 920. Combinations of any of the above should also be included within the scope of computer readable media that may be used to store source code for implementing the methods and systems described herein. Any combination of the features or elements disclosed herein may be used in one or more examples.

In describing preferred examples of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for processing an image of an event captured by an image capture device, comprising:
receiving the image at an image processor device positioned at the event;
using the image processor device to:
create metadata relating to the image; and
format the image for subject identification processing;
insert the metadata into the image; and
transmit the image, if one or more conditions exist at a site of the event, over a network to one or more servers operable to perform subject identification processing.

2. The method of claim 1, wherein the one or more conditions comprise signal strength between the image processor device and the network exceeding a predetermined value.

3. The method of claim 2, wherein the image processor device is further used to:
measure the signal strength between image processor device and the network; and
determine if the signal strength exceeds the predetermined value.

4. The method of claim 1, further comprising saving a master file of the image.

5. The method of claim 1, wherein format the image comprises reducing a file size of the image.

6. The method of claim 1, wherein the metadata include at least one of a date, a time, a location, an event ID, a zone ID, and a photographer ID.

7. The method of claim 1, wherein receiving the image comprises pulling the image from the image capture device upon the image being captured.

8. An image processing device comprising:
a processor; and
a memory coupled with the processor, the memory comprising executable instructions that when executed by the processor cause the processor to effectuate operations comprising:
receiving the image at the image processing device only when the image processing device is positioned at an event site;
creating metadata relating to the image;
formatting the image for subject identification processing;
inserting the metadata into the image; and
transmitting the image, if one or more conditions exist at the event site, over a network to one or more servers operable to perform subject identification processing.

9. The image processing device of claim 8, wherein the one or more conditions comprise the image processing device and the network having signal strength exceeding a predetermined value.

10. The image processing device of claim 9, wherein the operations further comprise:
measuring the signal strength between image processing device and the network; and
determining if the signal strength exceeds the predetermined value.

11. The image processing device of claim 8, further comprising:
saving a master file of the image.

12. The image processing device of claim 8, wherein formatting the image comprises reducing a file size of the image.

13. The image processing device of claim 8, wherein the metadata include at least one of a date, a time, a location, an event ID, a zone ID, and a photographer ID.

14. The image processing device of claim 8, wherein receiving the image comprises pulling the image from the image capture device upon the image being captured.

15. A method comprising:
positioning at least on image capture device and at least one image processing device at an event;
utilizing the image capture device to capture one or more images of the event, wherein the image includes at least one subject;
causing the image processing device to pull the one or more images from the image capture device upon the image capture device capturing the one or more images;
utilizing the image processing device to:
create metadata relating to the image; and
format the image for subject identification processing;
insert the metadata into the image; and
transmit the image, if one or more conditions exist at a site of the event, over a network to one or more servers operable to perform subject identification processing.

16. The method of claim 15, further comprising:
establishing a wireless connection between the image capture device and the image processing device.

17. The method of claim 15, further comprising:
establishing a wireless connection between the image processing device and the network;
measuring the signal strength between image processor device and the network; and
determining if the signal strength of the wireless connection exceeds a predetermined value; wherein the one or more conditions comprise the signal strength exceeding the predetermined value.

18. The method of claim 15, further comprising saving a master file of the image.

19. The method of claim 15, wherein formatting the image comprises reducing a file size of the image.

20. The method of claim 15, wherein the metadata include at least one of a date, a time, a location, an event ID, a zone ID, and a photographer ID.
